(19) United States
(12) Patent Application Publication
(10) Pub. No.: US 2011/0032419 A1
(43) Pub. Date: Feb. 10, 2011

(54) PICTURE PROCESSING APPARATUS AND PICTURE PROCESSING METHOD

(76) Inventors: Hidenori Sakaniwa, Yokohama (JP); Masahiro Ogino, Ebina (JP); Hiroki Sato, Shiki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/791,358

(22) Filed: Jun. 1, 2010

(30) Foreign Application Priority Data
Aug. 5, 2009 (JP) 2009-182044

(51) Int. Cl. H04N 7/01

(52) U.S. Cl. 348/452; 348/E07.003

(57) ABSTRACT

An interpolation frame producing method when a frame rate converting operation is carried out, the method comprising a motion vector detecting step for detecting a motion vector of a picture; a frame rate calculating step for calculating a frame rate based upon the detected motion vector; and an interpolation frame producing step for producing an interpolation frame based upon the calculated frame rate; in which in the frame rate calculating step, a movement feature amount of a picture is calculated from the motion vector detected in the motion vector detecting step; and the frame rate is calculated in such a manner that a frame rate of a picture, the movement feature amount of which exceeds a predetermined threshold value, becomes lower than a frame rate of a picture, the movement feature amount of which is smaller than, or equal to the predetermined threshold value.

### INCORPORATION BY REFERENCE

The present application claims priority from Japanese application JP2009-182044 filed on Aug. 5, 2009, the content of which is hereby incorporated by reference into this application.

### BACKGROUND OF THE INVENTION

1. Field of the Invention

The present invention generally relates to a picture processing apparatus. More specifically, the present invention is directed to a technique for producing an interpolation frame from frames contained within a picture signal so as to perform a frame rate conversion.

2. Description of the Related Art

Very recently, in order to improve unnatural motions such as blurring feelings and dithering feelings in displays of moving pictures, a specific attention has been paid to high image quality achieving techniques to which frame rate conversions are applied. In general, interpolation methods have been utilized by which interpolation frames are produced by employing inter-frame motion compensating processes based upon motion vector information between a present frame and a 1-preceding frame thereto so as to compensate smooth movements of pictures.

JP-A-2008-236098 has disclosed the below-mentioned technical ideas: That is, while JP-A-2008-236098 has the purpose of providing “the techniques capable of detecting more correctly the motion vectors and capable of converting the frame rates with the high image qualities”, “the interpolating methods of the horizontal/vertical/temporal directions in the interpolation frame producing unit are properly switched in response to the features of the movements between the frames” (refer to paragraphs [0005] and [0006]).

### SUMMARY OF THE INVENTION

The system of JP-A-2008-236098 can suppress collapse of the pictures when the frame rate converting operation is carried out based upon the motion compensating method by that since the motion vector histogram distribution is utilized, the judging precision for judging the features of the motion vectors to be detected is improved and the interpolation frame producing methods are switched. However, JP-A-2008-236098 does not describe such an interpolation frame producing method using a characteristic as to visual recognitions of human beings.

The present invention has been made to solve the above-described problem, and therefore, has an object to provide a technique capable of improving effects of transmitting original information of pictures by utilizing a characteristic as to visual recognitions of human beings with respect to an interpolation frame producing method when a frame rate converting operation is carried out based upon the motion compensating method.

To solve the above-described problem, a picture processing method, according to one aspect of the present invention, is featured by comprising: for instance, a motion vector detecting step for detecting a motion vector of a picture; a frame rate calculating step for calculating a frame rate based upon the detected motion vector; and an interpolation frame producing step for producing an interpolation frame based upon the calculated frame rate; in which in the frame rate calculating step, a movement feature amount of a picture is calculated from the motion vector detected in the motion vector detecting step; and the frame rate is calculated in such a manner that a frame rate of a picture, the movement feature amount of which exceeds a predetermined threshold value, becomes lower than a frame rate of a picture, the movement feature amount of which is smaller than, or equal to the predetermined threshold value.

In accordance with the above-described means, the below-mentioned effects can be achieved: That is, recognizing degrees of objects contained in pictures can be improved, so that understanding degrees as to stories of picture contents and scenes of the stories can be increased. In addition, a display with the present frame rate is switched to a display with a proper frame rate, so that a power consumption saving effect can also be realized.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram for showing an example as to an arrangement of a picture processing apparatus according to a first embodiment of the present invention.

FIG. 2 indicates a subjectively evaluated result related to the picture processing apparatus of the first embodiment in such a case that magnitudes of movements of pictures between frames are located within a certain threshold value.

FIG. 3 indicates a subjectively evaluated result related to the picture processing apparatus of the first embodiment in such a case that magnitudes of movements of pictures between frames are higher than, or equal to the certain threshold value.

FIG. 4 is an example for showing a motion vector histogram result obtained in a frame rate calculating unit 105.

FIG. 5 is an example for representing a relationship between frame rates and distribution values indicative of concentration degrees of motion vector histogram distributions obtained in the frame rate calculating unit 105.

FIG. 6 is an example for showing a frame rate selecting process sequence executed in the frame rate calculating unit 105.

FIG. 7 is an example for representing an interpolation frame producing process sequence performed in an interpolation frame producing unit 106.

FIG. 8 is an example for illustratively representing output pictures due to differences in motion vector histogram distribution values “H” contained in pictures.

FIG. 9 is a block diagram for showing an example as to an arrangement of a picture processing apparatus according to a second embodiment of the present invention.

FIG. 10 is an example of a range for detecting characters by a character detecting unit 900.

FIG. 11 is an example for indicating motion vector detecting operation when characters are scrolled along a lateral direction.

FIG. 12 is an example for indicating a relationship between frame rates and motion vector histogram distribution values detected by the character detecting unit 900.

FIG. 13 is an example for representing a frame rate selecting process sequence performed in the character detecting unit 900.

FIG. 14 is a block diagram for showing an example as to an arrangement of a picture processing apparatus according to a third embodiment of the present invention.

FIG. 15 shows an example in which a frame rate for each of sensing areas is calculated from a motion vector histogram result obtained by a frame rate calculating unit 105.

FIG. 16 indicates a hardware structural example of a picture display apparatus.

### DESCRIPTION OF THE EMBODIMENTS

Referring now to drawings, a description is made of embodiments according to the present invention.

### First Embodiment

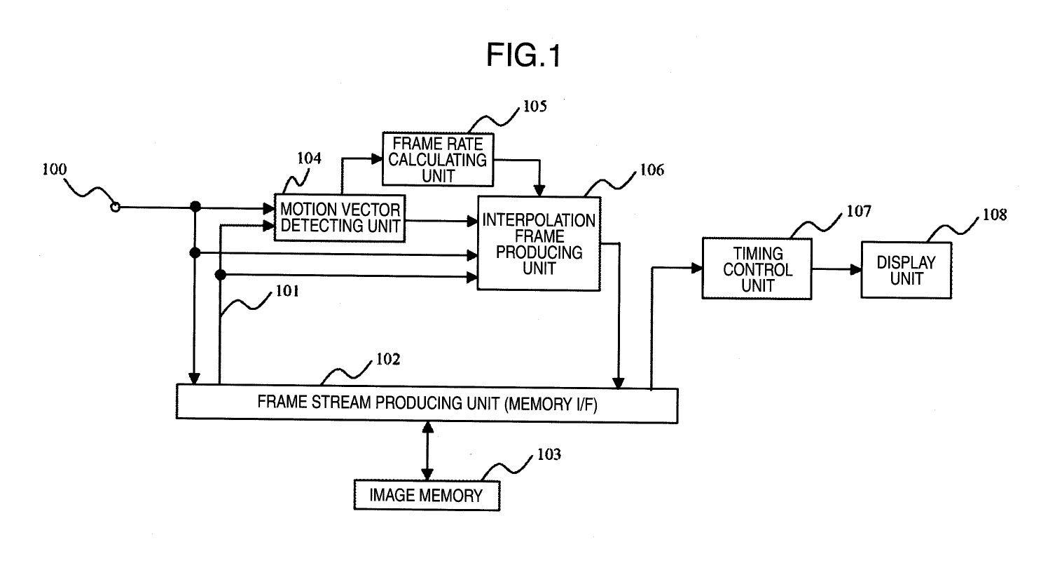

Firstly, a description is made of a first embodiment with reference to FIG. 1 to FIG. 8.

FIG. 1 is a block diagram for indicating one example as to an arrangement of a picture processing apparatus corresponding to the first embodiment.

In FIG. 1, reference numeral 100 shows an input signal (present frame signal); reference numeral 101 indicates another input signal (1-preceding frame signal); reference numeral 102 represents a frame stream producing unit (frame memory I/F); reference numeral 103 shows an image memory; reference numeral 104 indicates a motion vector detecting unit; reference numeral 105 represents a frame rate calculating unit; reference numeral 106 shows an interpolation frame producing unit; reference numeral 107 indicates a timing control unit; and reference numeral 108 denotes a display unit.

As the above-described input signals 100 and 101, the below-mentioned various sorts of input signals may be conceived, for instance, in decoded picture signal sources, pictures produced by decoding TV pictures received by tuners, pictures recorded on recording media such as CDs, DVDs, and Blu-ray Discs, pictures stored in hard disks, and picture contents on networks may be conceived.

The frame stream producing unit (memory I/F) 102 reads out image information from the image memory 103, produces a new frame stream by combining an original frame of the input signal 110 with the input signal 101 which temporally precedes with respect to the input signal 100 by 1 frame in addition to an interpolation frame, and outputs a picture signal to the display unit 108 at a frequency fitted to the produced new frame stream based upon pictures in the timing control unit 107.

The image memory 103 stores thereinto signals of original frames. Then, the frame stream producing unit (memory I/F) 102 produces the above-described interpolation frame while accessing the image memory 103.

Also, the image memory 103 further stores thereinto the produced interpolation frame. Then, while the interpolation frame producing unit 106 accesses the image memory 103, the interpolation frame producing unit 106 outputs the picture signal of the above-described new frame stream by combining the stored original frame with the interpolation frame.

The motion vector detecting unit 104 detects a motion vector between frames of the input signals 100 and 101, and detects a motion amount of images between the frames, or contained in the frames in the unit of an object as a direction vector. As a motion vector detecting method, for example, the block matching method, the gradient method, the phase correlation method, and other detecting methods may be employed.

The frame rate calculating unit 105 senses objects which are moving along a certain direction within a picture by employing information between the frames of the motion vector detecting unit 104, and then, assuming now that an object which occupies the largest area among the sensed objects corresponds to such an object which is wanted to be informed as a picture by a picture producing person, the frame rate calculating unit 105 calculates a frame rate based upon magnitudes of motion vectors of this object.

The interpolation frame producing unit 106 predicts an image which will probably be present between a frame and another frame based upon the information detected by the motion vector detecting unit 104 in response to the frame rate calculated from the frame rate calculating unit 105 so as to produce an interpolation frame.

The timing control unit 107 controls timing at which a plurality of picture frames are outputted in the corresponding frequency interval, while these picture frames correspond to the frame rate produced by the interpolation frame producing unit 106, and then, outputs the picture at a desirable frame rate to the display unit 108.

In accordance with the above-described control operation, an interpolation frame of a frame rate fitted to a visual characteristic is produced, and a picture can be outputted in a proper frame rate on a display unit, so that an improvement in visual recognizing degrees can be provided to a user. Such an event that a minimum display method capable of being recognized by human beings is realized may also eventually conduct a power consumption saving effect.

For instance, in such a case that a frequency of an input image is 60 Hz, the frame rate calculating unit 105 calculates a magnitude of a motion vector of a main object contained in the picture based upon motion vector information of the motion vector detecting unit 104, and selects a frame rate of 240 Hz corresponding to such a frame rate at which a human being can easily recognize motion of this object. In response to the selected frame rate, the interpolation frame producing unit 106 produces 3 sheets of interpolation frames between a present frame and a 1-preceding frame; produces a frame stream constructed of 240 frames per 1 second via the frame stream producing unit (memory I/F) 102; and the timing control unit 107 outputs the produced frame stream at the frequency of 240 Hz to the display unit 108. In this case, at the same time, the timing control unit 107 sets a driving frequency of 240 Hz with respect to the display unit 108.

In the above-described example, both the present frame and the 1-preceding frame have been inputted to the motion vector detecting unit 104 and the interpolation frame producing unit 106. Alternatively, not only a frame steam having a doubled frequency, but also frame streams at various frequencies may be outputted to the display unit 108 by a method for inputting a plurality of frames.

With employment of the above-described arrangement of the picture processing apparatus, a transfer efficiency of information with respect to human beings can be improved. Also, the frame rate can be set in the minimum level which can be recognized by human beings. As a result, the display unit 108 can be operated with lower power consumption, as compared with the conventional display apparatus to which the constant frame rate is set.

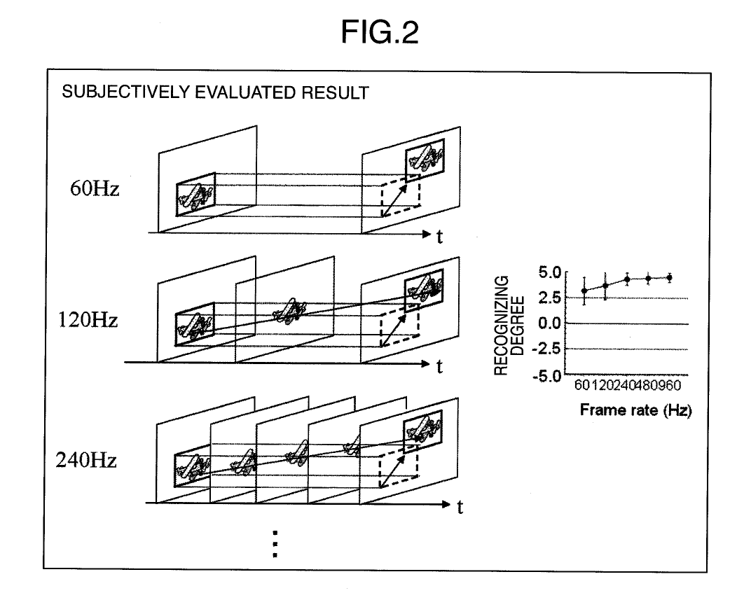

FIG. 2 shows a subjectively evaluated result related to the picture processing apparatus of the first embodiment in such a case that magnitudes of movement features of pictures among frames are located within a certain threshold value.

The above-described subjectively evaluated result was obtained as follows: That is, with respect to pictures in such a case that movement feature amounts “H” of motion vectors of a main object contained in the pictures between the input signal 100 and the input signal 101 are lower than, or equal to the certain threshold value, pictures whose frame rates have been changed from 60 Hz to 960 Hz were represented to examinees so as to subjectively evaluate their recognizing degrees.

In this case, the threshold value of the movement feature amount “H” of the motion vector is a value indicative of either a feature of pixels which constitute the picture or a feature of vector amounts (movement amounts and directions thereof) between frames of the main object. While various sorts of methods for capturing this feature may be conceived, there is such a report that accompanying movements of eyeballs is lower than, or equal to 30 degrees/second (refer to “Control Mechanism of Eyeball Movement” reported by NHK Technical Research Laboratory in 1966).

In this case, the following experiments were carried out: That is, assuming that a limit under which a picture of a main object indicative of a feature within pictures can be smoothly accompanied by eyeballs, namely, a feature amount of a picture as to the accompanying movement of 30 degrees/second of the eyeballs is defined as “H30”, experiments were carried out with respect to pictures within such a range (defined as “H1≦H30”) that the eyeballs can accompany the picture of the main object.

It should be understood that when a feature amount of movements is calculated from angular velocities, a center position of a rotation employed so as to calculate the angular velocities must be considered. In other words, even when an object moves at the same speed, an angular velocity of this object in the case that a distance measured from the own object up to a center of a rotation is short becomes higher than an angular velocity of this object in the case that a distance measured from the own object up to a center of a rotation is long.

As a consequence, in such a case that the feature amount “H30” of the picture is calculated from 30 degrees/second, a center of a rotation may be determined. Namely, a position of a user may be determined based upon a predetermined reference, for instance, visual positions of the user, which are recommended by respective picture processing apparatuses, positions which have been previously determined in accordance with sizes of display units for displaying thereon pictures, and other positions.

As subjective evaluation, the below-mentioned experiment was carried out: That is, while a picture which was scrolled at a certain speed along a lateral direction was represented on a display unit, approximately 10 examinees were required to describe their subjectively evaluated results based upon the VAS (Visual Analog Scale) system by defining as indexes, “the picture could not be completely recognized”; “the picture could be barely recognized”; and “the picture could be clearly recognized.”

As a result, the following fact could be recognized: That is, since the frame rate was improved, the recognizing degrees based upon the subjective evaluation could be improved in accordance with decreases of blurring widths of the pictures. In the range “H1” where the eyeballs can smoothly accompany the picture, since there was no clear difference in the recognizing degrees in the frame rates higher than, or equal to 240 Hz (namely, 240 Hz, 480 Hz, and 960 Hz), it is conceivable that the frame rate of 240 Hz is selected under which power consumption saving effects may be achieved by suppressing driving frequencies of display apparatuses. It should also be noted that the above-described frame rate selection is merely one example, setting of the frame rates may be properly changed.

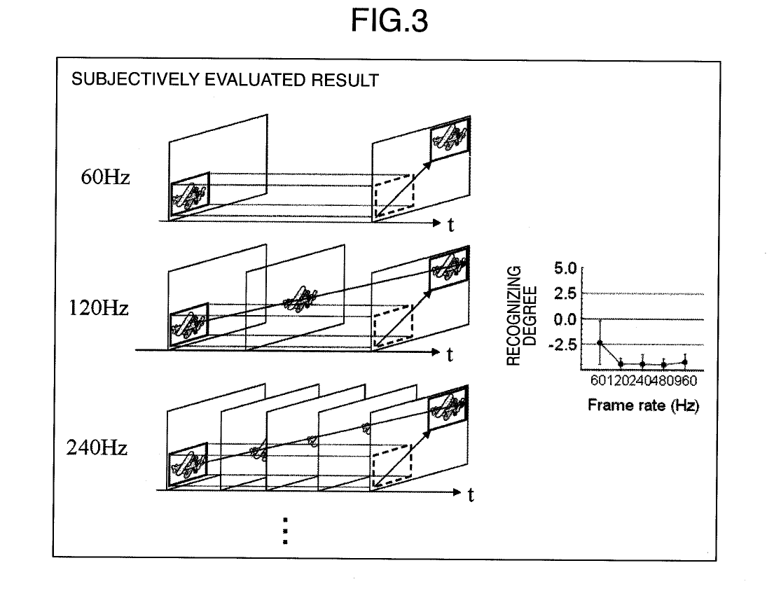

FIG. 3 shows a subjectively evaluated result related to the picture processing apparatus of the first embodiment in such a case that magnitudes of movement features of pictures among frames are higher than, or equal to the certain threshold value (namely, range where eyeballs can smoothly and hardly accompany pictures).

The above-described subjectively evaluated result was obtained as follows: That is, in an experiment similar to that of FIG. 2, with respect to pictures in such a case that movement feature amounts “H” of motion vectors of the input signal 100 and the input signal 101 are higher than, or equal to the certain threshold value “H30” (range where eyeballs can smoothly and hardly accompany pictures), such pictures whose frame rates have been changed were represented to examinees so as to subjectively evaluate their recognizing degrees.

As a result, there were many examinees who answered the below-mentioned recognitions: That is, if the frame rate was improved, then actual blurring widths of the pictures were decreased. However, since the objects moved at excessively high speeds, these objects could not be substantially recognized by the examinees. Nevertheless, the picture having the frame rate of 60 Hz could be recognized, so that the recognizing degree thereof was high.

This situation indicates such a fact: That is, if the frame rate is increased, then the movement of the picture becomes smooth, so that the examinees can recognize that the picture is smoothly scrolled at the high speed. However, there is a few person who can recognize that what picture was smoothly scrolled.

As to the above-explained recognitions, as previously described, it is conceivable that since there is such a report that the accompanying movement of the eyeballs is smaller than, or equal to 30 degrees/second, if the accompanying movement of the eyeballs exceeds this limit, then the eyeballs cannot smoothly accompany the pictures. In contrast to the accompanying movement, a jumping movement is a system which moves in response to a speed of a visual object, while this speed may reach 200 degrees/second to 600 degrees/second (refer to “The Neurology of Eye Movement” written by R. John Leight, et al. in 1984).

In other words, the above-described publication describes some possibilities under which even when pictures which move very fast cannot be accompanied by eyes, such a picture which quickly moves at a jumping speed can be sensed based upon the jumping movement of the eyeballs. As to 60 Hz-displaying of a picture which moves fast, since an interpolation frame between a present frame and a 1-preceding frame is not produced, this picture may be viewed as such a jumping picture which moves over a long distance. As a result, this jumping picture may constitute a visual object which should be traced in a similar manner to the jumping movement of the eyeballs, and thus, it is conceivable that a recognizing degree of this jumping picture could be improved.

In other words, as to pictures which move at speeds higher than, or equal to the threshold value, these quickly moving pictures are represented by reducing frame rates thereof to 60 Hz. As a result, it is conceivable that there are some possibilities that recognizing degrees of these quickly moving pictures may be improved.

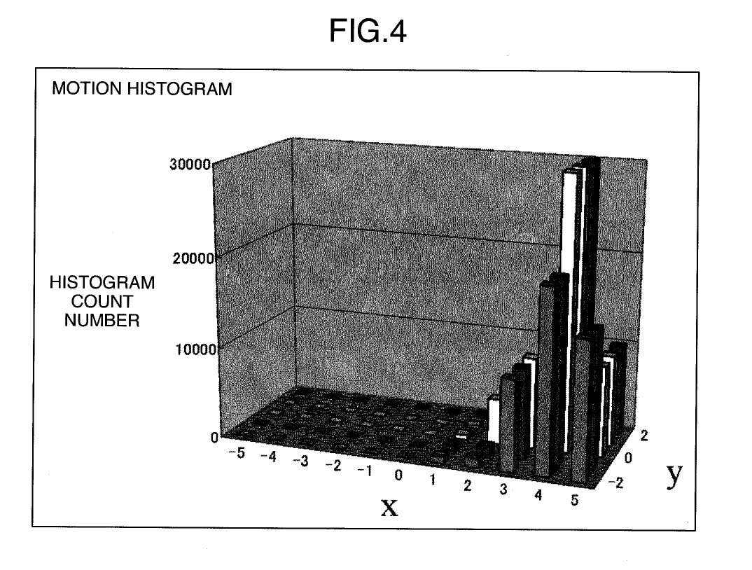

FIG. 4 is a diagram for indicating one example of a result of a motion vector histogram detected by the motion vector detecting unit 104 of the first embodiment.

While a lateral direction of a two-dimensional picture is defined as an x direction and a longitudinal direction thereof is defined as a y direction, this motion vector histogram represents such a case that magnitudes of movements in motion vectors detected by the motion vector detecting unit 104 are vertical y-direction vectors (−2, −1, 0, +1, +2) and horizontal x-direction vectors (−5, −4, −3, −2, −1, 0, +1, +2, +3, +4, +5); and numbers of motion vectors having the same components are processed based upon the histogram, and are graphically represented along a height axial direction. In this example, it is possible to read that components having motion vectors whose magnitudes are +4 and +5 along the x direction are concentrated; and pictures among frames are scrolled along the right direction. As previously described, a feature of movement contained in the picture can be judged by employing the histogram distribution of the motion vectors.

Since the feature of the histogram distribution of the motion vectors is viewed, it is possible to predict scrolling of the main object contained in the picture. For example, in the case that a histogram distribution of motion vectors in a certain sensing area detected by the motion vector detecting unit 104 has such a feature as represented in FIG. 4, numbers of detected motion vectors having magnitudes of +4 along the x direction and magnitudes of +2 along the y direction are large. As a result, it is possible to predict that such a picture is represented, in which a certain object is moving along this direction within the sensing area.

In other words, if components having motion vectors are concentrated to motion vector information having a certain feature and a distribution value indicative of this motion vector histogram distribution is calculated, then a motion feature of a picture can be detected.

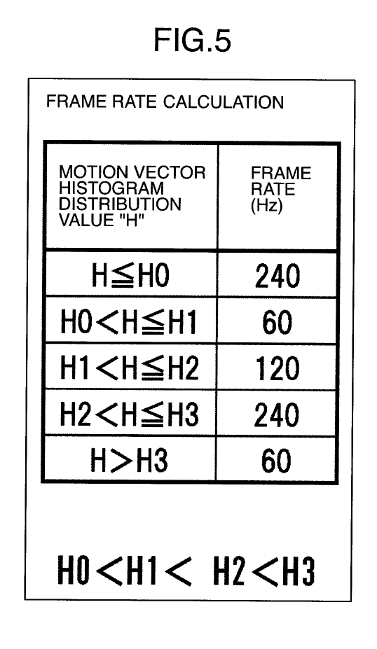

FIG. 5 is an example for showing a relationship between frame rates and distribution values “H”, while the distribution values “H” indicate concentration degrees of motion vector histogram distributions employed in the frame rate calculating unit 105 of the first embodiment.

Firstly, the frame rate calculating unit 105 calculates a motion vector histogram distribution value “H” from a histogram distribution of motion vectors detected by the motion vector detecting unit 104. As this calculation method, for instance, it is conceivable to utilize typical values such as an average value, a central value, and a mode, which are employed in a basic statistical amount of a statistical data processing. It is so assumed that the distribution value (movement feature amount) “H” is calculated by utilizing a formula capable of conducting a motion feature based upon a motion direction and a dispersing way of magnitudes of movements, and a histogram value (motion vector accumulated number).

This distribution value “H” corresponds to a certain vector amount, and indicates both a magnitude and a direction of movement as to either an entire screen or a main object. In the case that a numeral value of a distribution value “H” is large, this distribution value “H” indicates that a motion amount between 1 frame is large, and indicates a moving direction from which place to which direction on the screen. For example, in the case that a screen is scrolled along the lateral direction, although there is a move amount to a direction other than the scrolling direction, a feature amount along the scrolling direction is large, and also, as the distribution value “H”, both a scrolling speed and a feature amount of this direction are represented. The relationship between the distribution values “H” and the frame rates establishes a corresponding relationship capable of improving recognizing degrees of users by utilizing the subjectively evaluated results.

Since the moving direction and the dispersing way of the magnitudes of the movements of this method and a histogram value are employed, in such a case that the histogram value is large, it is predictable that dimensions of objects are large, which move with same movement within a sensing area by the motion vector detecting unit 104. In other words, it is conceivable that a picture producing person photographs, or CG (Computer Graphic)-synthesizes objects with each other, while the first-mentioned objects are handled as the main object. If such a prediction is made, then a picture can be represented in such a manner that a recognizing degree of information which is wanted to be informed by the picture producing person is increased. Not only sensing area information, but also motion vector histogram distribution values as to a plurality of sensing areas are considered, so that feature values of the entire picture can be furthermore calculated.

Also, as methods capable of improving recognizing degrees in correspondence with subjectively evaluated results, the below-mentioned method may be conceived: That is, for example, in the case that a feature amount “H” of a movement is smaller than, or equal to a certain threshold value “H0”, a judgement is made from the subjectively evaluated result of FIG. 2 that a picture having no specific feature of a movement (namely, entire area moves in inconsistent manner) is presently displayed, so that the frame rate is set to 240 Hz, since the smooth of the picture is considered as an important aspect; in a range “H0<H≦H1” of very small movements, a picture is approximated to a still image, so that the frame rate is set to 60 Hz, since saving of the power consumption rather than the smooth of the moving picture is considered; in a range of “H1<H≦H2” of a certain movement, the frame rate is set to 120 Hz, since both saving of the power consumption and the recognizing degree are considered; in a range of “H2<H≦H3”, the frame rate is set to 240 Hz, since the smooth of the picture is considered at a top priority; and also, in the case of “H>H3” larger than the certain threshold value, the frame rate is set to 60 Hz based upon the subjectively evaluated result of the recognizing degrees shown in FIG. 3 (note that H0<H1<H2<1H3).

It should also be understood that the threshold value “H3” may be alternatively substituted by the threshold value of “H30” corresponding to the above-described feature amount of the picture of the accompanying movement “30 degrees/second” of the eyeballs.

In the above-described example, as the motion vector histogram distribution value “H”, the plurality of threshold values from “H0” to “H3” have been provided. Alternatively the frame rates may be controlled based upon two sorts of threshold values, which are higher, or lower than 30 degrees/second equal to the accompanying movement limit of the eyeballs. If the threshold values are controlled in a precise manner, as explained in the above example, there are some possibilities that saving of the power consumption may be realized while the recognizing degrees may be considered.

In the case of H>H3, since the display unit is driven by the frame rate of 60 Hz by utilizing such a hardware driven by the frame rate of 240 Hz, there is an electronic margin in a hardware structure aspect. As a result, instead of not producing an interpolation frame, other picture processings may be additionally employed. For instance, there are some possibilities that processing movement is fast and a picture of a picture source during photographing operation is also blurred. As a result, in this case, after the picture is interpolated by employing the ultra-resolution technique or the like, the interpolated picture may be displayed in the frame rate of 60 Hz. Generally speaking, the above-described ultra-resolution technique implies such a technique capable of improving blurred image portions of an image and roughs of edges thereof, which are produced in the case that up-scaled image enlarging processes (bilinear processing, bicubic processing etc.) are carried out.

Furthermore, the ultra-resolution technique may involve another technique capable of processing, or clarifying a picture by utilizing a value which is predicted based upon a plurality of images having low resolution. In accordance with this technique, for example, there are many cases in moving picture data that resembling images are collected within temporally near frames; movements between frames of 1 pixel may be easily predicted; and it is possible to predict that which image is an original image so as to produce image data in a high precision manner.

Alternatively, the above-described frame rates may be set by a user via a user interface. In this alternative case, a picture scrolled at a certain speed is represented to the user every frame rate; the user is required to answer that which scrolled picture may be easily viewed; and thus, such a frame rate which is most suitable for the user is calculated based upon the answered result. As a consequence, there is a merit that the frame rate of the picture capable of improving the recognizing degree of this picture may be calculated.

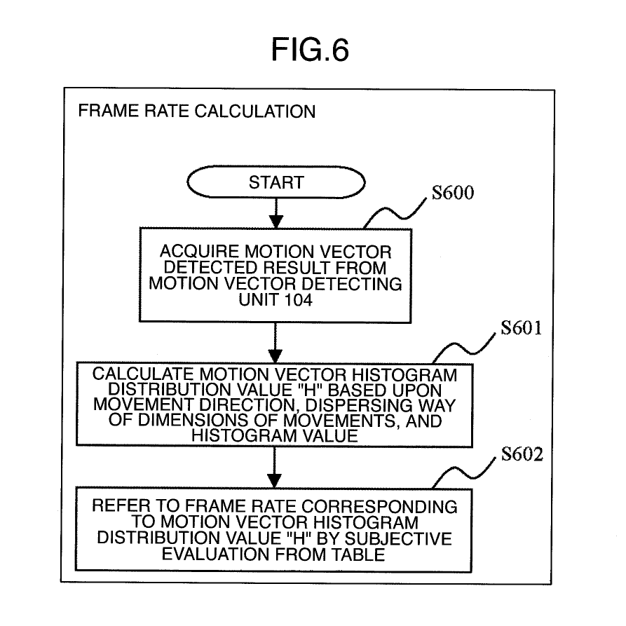

FIG. 6 is an example for showing a frame rate selecting process sequence performed in the frame rate calculating unit 105 of the first embodiment.

Firstly, the frame rate calculating unit 105 acquires a motion vector detected result for each of sensing areas from the motion vector detecting unit 104 (S600). Next, the frame rate calculating unit 105 counts a total number of vectors every motion vector, calculates such a motion vector histogram distribution as represented in FIG. 4, and defines a typical value of features of the motion as a motion vector histogram distribution value “H” (S601).

The motion vector histogram distribution value “H” is an index which indicates a feature of motion of a main object contained in a picture by employing a movement direction, a dispersing way of magnitudes of movements, and a histogram value, and furthermore by considering a motion vector histogram distribution value for each of the sensing areas, or motion vector histogram distribution values for a plurality of the above-described sensing areas.

In the case that the information about the plurality of sensing areas is considered, if sensing areas are located adjacent to each other, in which the motion vector histogram distribution values are similarly dispersed, then it is possible to grasp that objects which are moving within the picture extend over the plurality of sensing areas, and therefore, possible to predict dimensions (namely, occupying ratio within 1 screen) of the objects which are moving within the picture.

Also, in such a case that 1 screen may be divided and sub-divided screens may be separately controlled based upon an LED backlight control, a feature amount for each of the sensing areas may be calculated so as to control the original frame rate as such a frame rate capable of improving a recognizing degree every sensing area.

Next, the frame rate calculating unit 105 refers to a frame rate corresponding to the motion vector histogram distribution value “H” from a table which indicates a relationship between the frame rates and the motion vector histogram distribution values “H” formed based upon the subjectively evaluated results of FIG. 5 (S602).

In accordance with the above-described frame rate processing, the frame rate calculating unit 105 can calculate the motion vector histogram distribution value “H” based upon the motion vector detected result every sensing area acquired from the motion vector detecting unit 104, and thus, can select such a frame rate that the subjectively evaluated result (recognizing degree) corresponding to the motion vector histogram distribution value “H” may become optimum.

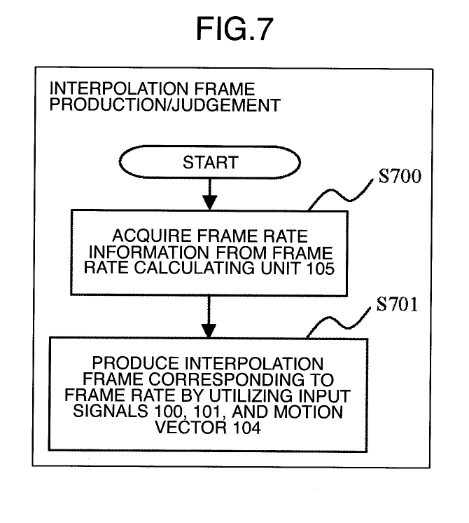

FIG. 7 is a diagram for indicating an example of an interpolation frame producing process sequence performed in the interpolation frame producing unit 106 of the first embodiment.

The interpolation frame producing unit 106 acquires frame rate information which is optimized for displaying a picture, from the frame rate calculating unit 105 (S700). The interpolation frame producing unit 106 produces an interpolation frame corresponding to the acquired frame rate by utilizing the input signals 100 and 101, and a result detected from the motion vector detecting unit 104 between frames thereof. (S701).

For instance, when a frame rate of an input signal is 60 Hz in such a case that the frame rate of 120 Hz is selected, the interpolation frame producing unit 106 produces 1 sheet of an interpolation frame between input key frames. When a frame rate of an input signal is 240 Hz, the interpolation frame producing unit 106 produces 1 sheet of an interpolation frame between the above-described interpolation frame produced when the frame rate of the input signal is 120 Hz and an input key frame (present frame), and also, produces 1 sheet of another interpolation frame between the above-explained interpolation frame produced when the frame rate of the input signal is 120 Hz and another input key frame (preceding frame), namely produces 3 sheets of interpolation frames in total.

As a consequence, the interpolation frame producing unit 106 can produce a plurality of the interpolation frames, which are required in order to display the pictures in the frame rates capable of improving the recognizing degrees of the display contents calculated by the frame rate calculating unit 105.

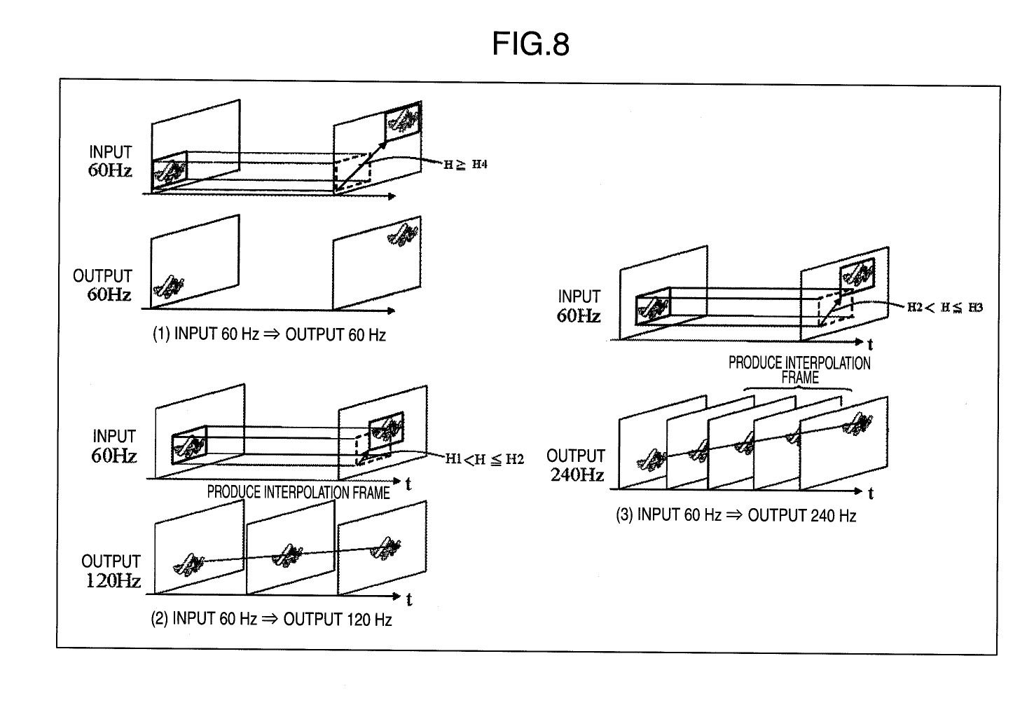

FIG. 8 is a diagram for illustratively representing output pictures based upon differences in the motion vector histogram distribution values “H” contained in the picture of the first embodiment.

Reference numeral (1) of FIG. 8 shows an example in such a case that the motion vector histogram distribution value “H” of the main object (airplane) between frames of the input picture is higher than, or equal to the threshold value “H3.” This example indicates such an output picture that while movement of the main object between 1 frame is large, the frame rate of 60 Hz under which the recognizing degree based upon the subjectively evaluated result was high is set in order to improve the recognizing degree of the main object.

Reference numeral (2) of FIG. 8 is an example of H1<H≦H2, and indicates such an output picture that the frame rate of 120 Hz under which the recognizing degree based upon the subjectively evaluated result was high is set with respect to an input picture having a frame rate of 60 Hz.

Reference numeral (3) of FIG. 8 is an example of H2<H≦H3, and indicates such an output picture that the frame rate of 240 Hz under which the recognizing degree based upon the subjectively evaluated result was high is set with respect to the input picture having the frame rate of 60 Hz.

As shown in the first embodiment, since the frame rate is changed in response to the movements of the picture, the picture which can be easily recognized by the user can be outputted. In addition, since the driving frequency of the display apparatus is suppressed, the power saving effect thereof may be achieved.

### Second Embodiment

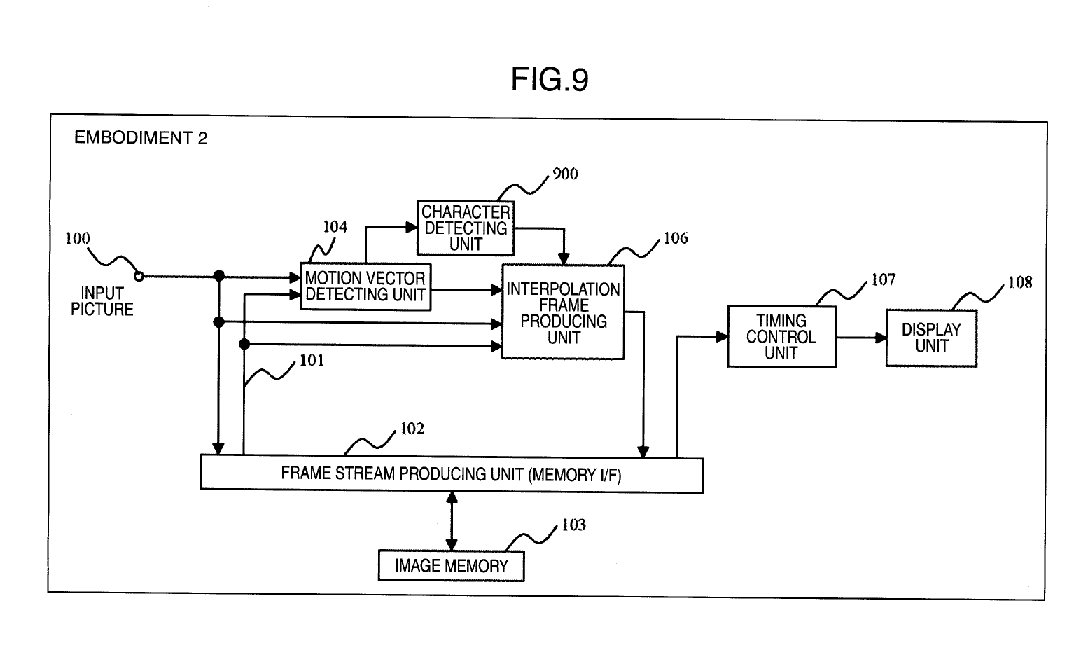

Next, a description is made of a second embodiment of the present invention with reference to FIG. 9 to FIG. 13. FIG. 9 is a block diagram for showing an example as to an arrangement of a picture processing apparatus according to the second embodiment.

In comparison with the arrangement of FIG. 1, the picture processing apparatus of the second embodiment is arranged by replacing the above-described frame rate calculating unit 105 by a character detecting unit 900. Since modules having the same structures shown in FIG. 9 have already been described in FIG. 1, explanations thereof are omitted.

In the arrangement shown in FIG. 1, the frame rates capable of improving the recognizing degrees have been calculated based upon the movement feature amounts of the pictures by employing the motion vector histogram distribution values “H” of the pictures. In the arrangement of the second embodiment shown in FIG. 9, the below-mentioned method will now be explained: That is, the character detecting unit 900 detects whether or not character scrolling (character ticker) is present, and selects a frame rate of a picture in order that recognizing degrees of characters contained in the picture become optimum.

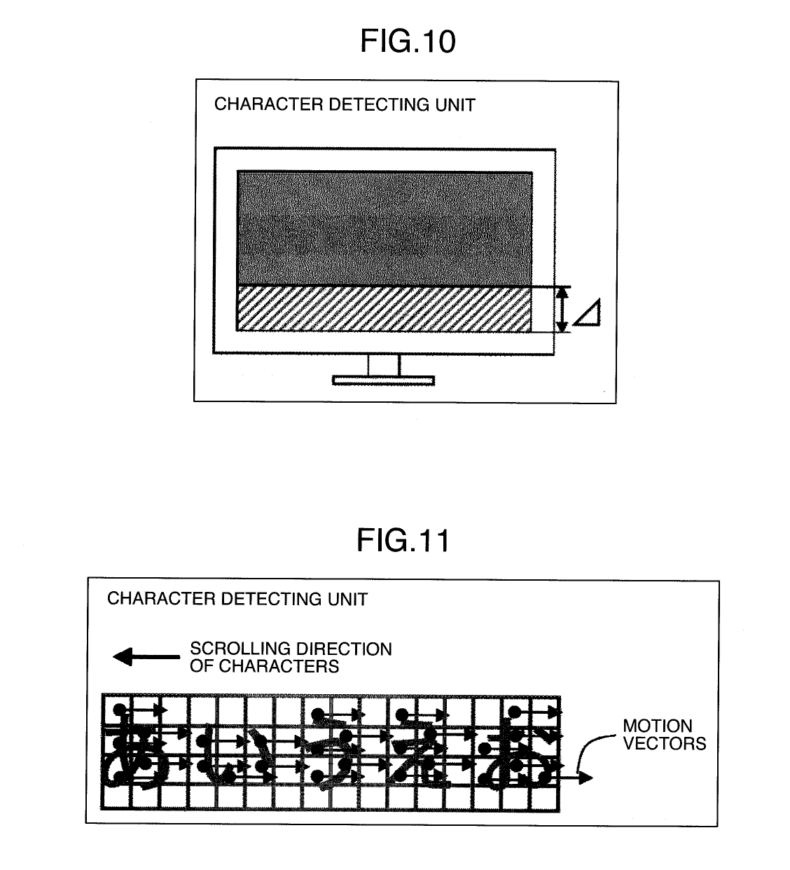

FIG. 10 is a diagram for representing an example of a range where characters are detected by the character detecting unit 900 of the second embodiment.

There are some cases that in pictures firstly known as broadcasting contents (groundwave TV, satellite TV, cable TV etc.), names of staffs who have produced programs of the pictures are scrolled along the lateral direction (staff roll, character ticker etc.) in such a range having a height “Δ” located in a lower portion of a screen as indicated in FIG. 10.

While there is an example for supposing that characters appear within this range having a portion of the height “Δ”, the character detecting unit 900 detects the characters and calculates scrolling speeds of the characters as to this range by utilizing a feature of character scrolling shown in FIG. 11. It should be understood that although the scrolling speeds of the characters with respect to the entire screen may be calculated, since the calculation range is delimited, there is an advantage capable of achieving high-speed processing for detecting the characters.

FIG. 11 is an example for showing detections of motion vectors when characters are scrolled along the lateral direction in the second embodiment, namely, “HIRAGANA” characters of “a i u e o” are horizontally scrolled from a right side to a left side on a screen.

While pixels are divided in the unit of a macro block, when motion vectors of a difference between a present frame and a preceding frame every macro block are considered, it is possible to grasp that as represented in FIG. 11, these motion vectors become such motion vectors having the same lengths along the same direction in the scrolled character ticker. In other words, assuming now that the characters are scrolled along the lateral direction within the range having the height “Δ” shown in FIG. 10, when motion vectors for each of the macro blocks are detected, a large number of motion vectors having the same dimensions along the same direction can be detected.

While this feature is utilized, it is possible to predict and detect that the characters are being scrolled by utilizing the motion vector histogram of FIG. 4.

As to detections of the characters, since edges of luminance in the characters are steep with respect to the background, if an edge detecting method and other detecting methods are utilized, then precision of the character detections may be furthermore increased.

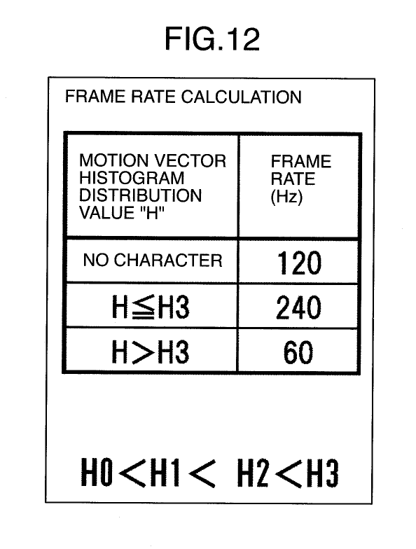

FIG. 12 is an example for representing a relationship between frame rates and motion vector histogram distribution values “H” detected in the character detecting unit 900 of the second embodiment.

Similar to FIG. 5 indicated in the frame rate calculating unit 105 of the first embodiment, FIG. 12 is such an example for establishing the relationship between the frame rates and the motion vector histogram distribution values “H” based upon the recognizing degree results of the subjective evaluation shown in FIG. 2 and FIG. 3.

While there is no feature in the motion vector histogram distribution value “H” based upon the subjectively evaluated result of FIG. 2 and the character detecting unit 900 cannot detect any character within the range having the height “Δ”, when a picture content having no character is displayed, a moving picture can be displayed which is smoother than that of the input signal having the frame rate of 60 Hz, and such a frame rate of 120 Hz capable suppressing power consumption is employed.

When the threshold value “H0” to the threshold value “H3” of the movement feature amount “H” utilized in the explanation of FIG. 5 are employed, in the case of a range of “H>H3”, if a movement of a character becomes fast and a frame rate is increased, then a recognizing degree of the character is conversely decreased, so that the frame rate is set to 60 Hz. In such a case that a character can be detected in the range having the height “Δ” and in a range of “H≦H3”, the frame rate is set to 240 Hz at which an improvement in the recognizing degree of the character can be expected.

Alternatively, the above-described frame rates may be set by a user via a user interface. In this alternative case, a picture scrolled at a certain speed is represented to the user every frame rate; the user is required to answer that which scrolled picture may be easily viewed; and thus, such a frame rate which is most suitable for the user is calculated based upon the answered result.

With the execution of the above-described processing, the character detecting unit 900 can calculate a motion vector histogram distribution value “H” of the character ticker based upon the motion vector detected result for each of the sensing areas from the motion vector detecting unit 104, and can select such a frame rate that recognizing degrees of the characters based upon the subjectively evaluated value corresponding to the calculated motion vector histogram distribution value “H” can become optimum.

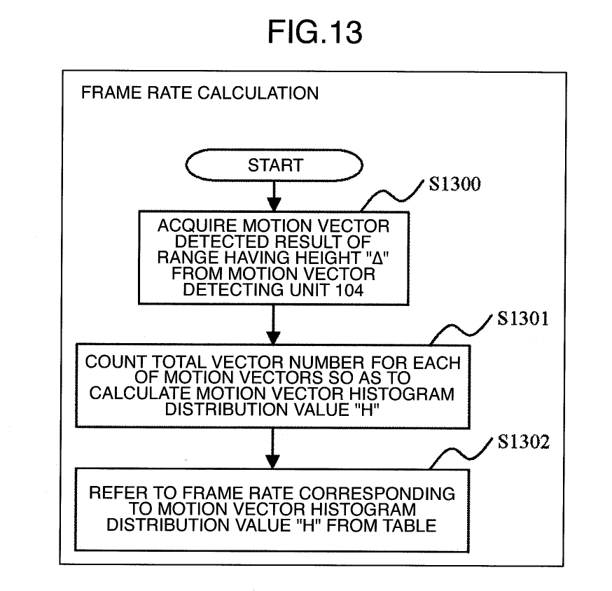

FIG. 13 is an example for showing a frame rate selecting process sequence executed in the character detecting unit 900 of the second embodiment.

The character detecting unit 900 acquires a motion vector detected result from the motion vector detecting unit 104 as to a designated area (namely, range having height “A”) (S1300).

Next, the character detecting unit 900 counts a total vector number every motion vector so as to calculate such a motion vector histogram distribution as shown in FIG. 4, and defines a typical value of a feature of this motion as a motion vector histogram distribution value “H” (S1301).

Next, the character detecting unit 900 refers to a frame rate at which a recognizing degree of characters corresponding to the motion vector histogram distribution value “H” is high from the table of FIG. 12 which indicates the relationship between the frame rates and the motion vector histogram distribution values “H” (S1302).

In accordance with the above-described processing, the character detecting unit 900 can check whether or not a character scrolling operation in a certain sensing area is performed, can calculate a movement feature amount thereof, and can select such a frame rate that a subjectively evaluated result (recognizing degree) of the character becomes optimum, which corresponds to the calculated movement feature amount. In other words, the character detecting unit 900 can check whether or not the character is present, can predict the scrolling speed, and can select the frame rate capable of improving the recognizing degree of the character based upon the motion vector detected result acquired when the character ticker is supposed.

### Third Embodiment

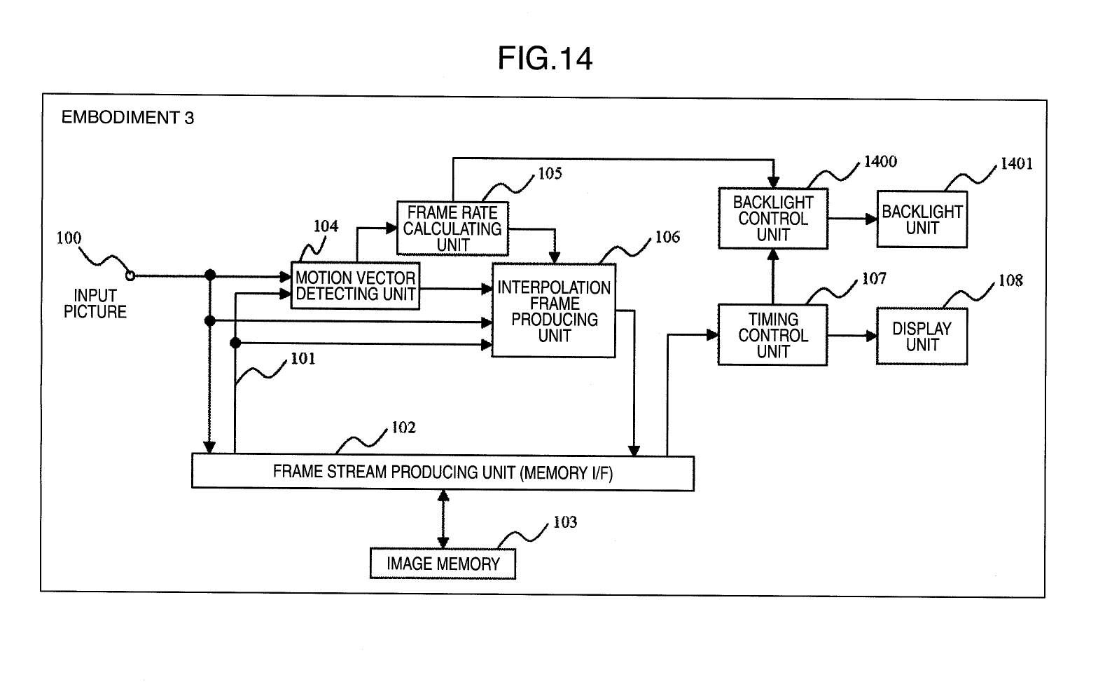

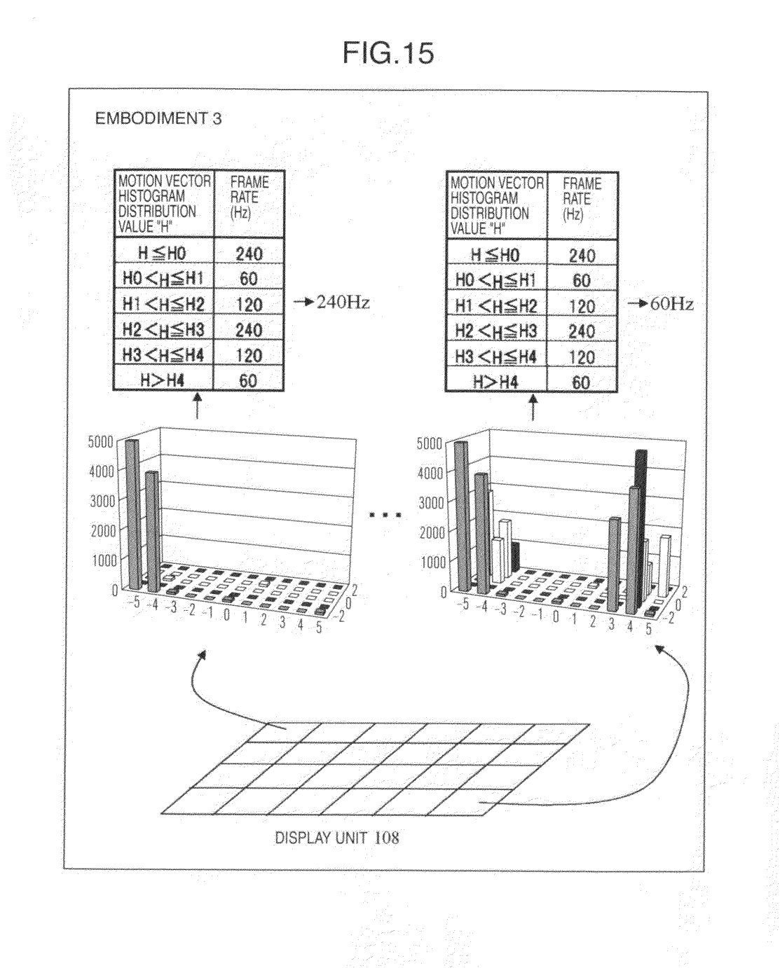

Next, a description is made of a third embodiment of the present invention with reference to FIG. 14 and FIG. 15. FIG. 14 is a block diagram for showing an example as to an arrangement of a picture processing apparatus according to the third embodiment.

In comparison with the arrangement of FIG. 1, the picture processing apparatus of the third embodiment is arranged by additionally employing a backlight control unit 1400 and a backlight unit 1401, which suppose a liquid crystal display. Since modules having the same structures shown in FIG. 14 have already been described in FIG. 1, explanations thereof are omitted.

In liquid crystal displays, backlight controls are conceivable as methods for compensating delays of responses of liquid crystal. Although response speeds of liquid crystal display panels may be determined based upon physical characteristics of liquid crystal, these response speeds of the liquid crystal display panels may be increased based upon the below-mentioned method: That is, for instance, in such a case that a certain display area of a liquid crystal display panel is changed from white into black when a voltage is applied to liquid crystal thereof in such a manner that light of a backlight is cut off so as to change transmittance of the liquid crystal, if the backlight is turned OFF, then this certain display area may be represented in black without waiting for responses of the liquid crystal. In addition, precise responses for respective display areas may be controlled by utilizing LED backlights, and the like.

In the arrangement of FIG. 14, the frame rate calculating unit 105 can calculate an optimum frame rate for each of the display areas by utilizing a motion vector histogram distribution value “H” utilized therein for each of the display areas. As a result, the calculated optimum frame rate is transmitted to the backlight control unit 1400 so as to control the backlight unit 1400, so that since a visible liquid crystal response speed for each of the display areas is increased, recognizing degrees of the display areas by the user can be furthermore improved.

When the frame rate calculating unit 105 calculates the frame rates capable of improving the recognizing degrees based upon the motion vector histogram distribution values utilized therein for the respective display areas, the same method as that of the first embodiment shown in FIG. 5 is utilized.

Also, in the case that a liquid crystal panel having a slow response speed is employed in order to reduce a production cost, there is such an advantage that the backlight control unit 1400 can improve a visible response speed for each of display areas and can improve a visible recognizing degree in low cost.

For example, in the case that a liquid crystal panel operable in the frame rate of 120 Hz is utilized, when a display area thereof is changed from white to black, if the backlight control unit 1400 controls a backlight thereof to be turned OFF while a voltage is applied to liquid crystal so as to change transmittance of the liquid crystal, then the light which is originally derived from the backlight disappears before the liquid crystal cuts off the light. As a result, since this display area can be quickly changed into black, it is possible to realize such a liquid crystal panel operable at a visible response speed of 240 Hz.

FIG. 15 shows an example in which a frame rate for each of display areas is calculated based upon a motion vector histogram result obtained in the frame rate calculating unit 105 of the third embodiment.

As represented in FIG. 15, in such a case that the display unit 108 has been divided into display areas which can be controlled by the backlight control unit 1400, the frame rate calculating unit 105 calculates a motion vector histogram distribution value “H” for each of the divided display areas, and then, calculates such a frame which is fitted to a recognizing degree of a subjectively evaluated result based upon the calculated distribution value “H.”

With the execution of the above-described processing, the frame rate capable of improving the recognizing degree for each of the display areas can be set, and thus, since the backlight control unit 1400 can improve the visible liquid crystal response speed for each of the display areas, the visible recognizing degree for each of the display areas can be improved.

In the present example, the frame rate has been calculated by utilizing the motion vector histogram distribution value “H” acquired for each of the display areas. Alternatively, a backlight control may be carried out by combining a plurality of display areas with each other based upon an analysis result as to the motion vector histogram distribution values for the plurality of display areas.

In this alternative case, in such a case that a main object moves within a picture by extending over the plurality of display areas, it may be conceived to eliminate collapse of the picture, which is caused by that frame rates are changed at joint portions of the main object in interrupted portions of the display areas.

### Other Embodiments

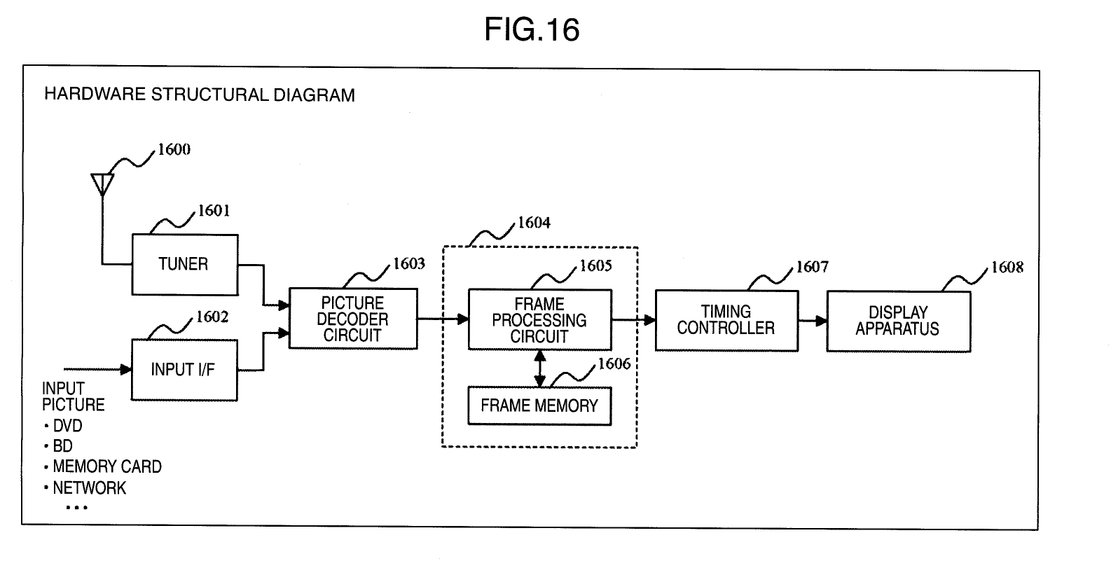

FIG. 16 indicates an example of a hardware structure of a picture display apparatus employed in the respective embodiments.

In FIG. 16, reference numeral 1600 indicates an antenna; reference numeral 1601 shows a tuner; reference numeral 1602 represents an input I/F; reference numeral 1603 is a picture decoder circuit; reference numeral 1604 indicates a picture processing apparatus portion; reference numeral 1605 represents a frame processing circuit; reference numeral 1606 shows a frame memory; reference numeral 1607 indicates a timing controller; and reference numeral 1608 shows a display apparatus.

The antenna 1600 is a circuit for inputting broadcasting waves transmitted from an external source such as a CATV, or an antenna apparatus for receiving ground-wave digital broadcasting programs, or satellite broadcasting programs such as BS/CS. The tuner 1601 corresponds to a frequency tuning circuit, namely, an electronic components, or a circuit employed in order to receive broadcasting waves. The input I/F 1602 corresponds to an input I/F of picture information and/or sound information stored in DVDs, BDs, memory cards, networks, and the like, namely, such an input I/F for accepting various sorts of picture inputs via a composite signal terminal, a D terminal, an HDMI terminal, an Ethernet (RJ-45) terminal, an IEEE 1394 terminal, or wireless systems such as IEEE 802.11 series, LTE, and Bluetooth.

The picture decoder circuit 1603 corresponds to a circuit for decoding data coded in accordance with a predetermined rule, namely, is a circuit equivalent to an MPEG decoder, and the like. The picture processing apparatus 1604 corresponds to an apparatus constituted by circuits on which processing units containing the frame rate calculating unit 105 and the interpolation frame producing circuit 106 shown in the first embodiment to the third embodiment have been mounted, while the picture processing apparatus 1604 enters pictures in the unit of a frame as an input signal, which have been decoded by the picture decoder circuit 1603 as pictures and sounds.

While the frame processing circuit 1605 contains the vector detecting unit 104, the frame rate calculating unit 105, the interpolation producing unit 106, and the frame stream producing unit (memory I/F) 102, the frame processing circuit 1605 produces an interpolation frame via the frame memory 1606 containing the image memory 103.

The timing controller 1607 containing the timing control unit 107 performs a timing control based upon the frame rate obtained from the picture processing apparatus 1604 in order to display an output on the display apparatus 1608.

It should be understood that the above-described embodiment modes have been merely exemplified in order to describe the inventive idea of the present invention, but do not intend to restrict the technical scope thereof only to these embodiment modes. A person skilled in the art can embody the present invention in other various modes without departing from the gist of the present invention. For instance, although the sensing area in the character detecting unit 900 has been defined in the range having the height “Δ” of the lower portion of the screen in the above-described second embodiment, a longitudinal center portion of a screen may be alternatively defined as the sensing area, as realized in a staff roll of a movie. Also, the frame rate calculating unit 105 provided in the arrangement of the above-explained third embodiment may be alternatively replaced by the character detecting unit 900 employed in the arrangement of the second embodiment. Further, in such a case that the picture processing apparatus is assembled in a system having a user interface, such a mode as “recognizing degree up mode” may be provided; and only when the operation mode is set to this “recognizing degree up mode”, the picture processing apparatus may be alternatively operated.

It should be further understood by those skilled in the art that although the foregoing description has been made on embodiments of the invention, the invention is not limited thereto and various changes and modifications may be made without departing from the spirit of the invention and the scope of the appended claims.

1. A picture processing apparatus for producing an interpolation frame of a picture signal, comprising:
a motion vector detecting unit for detecting a motion vector of a picture;
a frame rate calculating unit for calculating a frame rate based upon the motion vector detected by said motion vector detecting unit; and
an interpolation frame producing unit for producing an interpolation frame based upon the frame rate calculated by said frame rate calculating unit;
wherein said frame rate calculating unit calculates a movement feature amount of the picture from the motion vector detected by said motion vector detecting unit, and calculates the frame rate in such a manner that a frame rate of a picture, the movement feature amount of which exceeds a predetermined threshold value, becomes lower than a frame rate of a picture, the movement feature amount of which is smaller than, or equal to said predetermined threshold value.

2. A picture processing apparatus as claimed in claim 1, further comprising:
a display unit for displaying thereon a picture;
wherein said display unit displays thereon the picture in the frame rate calculated by said frame rate calculating unit.

3. A picture processing apparatus as claimed in claim 1 wherein:
said motion vector detecting unit detects a motion vector histogram distribution value for each of areas of the picture; and
said frame rate calculating unit includes means for calculating a movement feature amount of the picture by employing the motion vector histogram distribution value for each of said areas detected by said motion vector detecting unit.

4. A picture processing apparatus as claimed in claim 3 wherein:
said frame rate calculating unit utilizes, as a typical value, any one of an averaged value, a center value, and a mode of the motion vector histogram distribution value for each of said areas.

5. A picture processing apparatus as claimed in claim 1, wherein
the picture, the movement feature amount of which exceeds said predetermined threshold value, corresponds to a picture in which an angular velocity of an object thereof is higher than 30 degrees/second; and the picture, the movement feature amount of which is smaller than, or equal to said predetermined threshold value, corresponds to a picture in which an angular velocity of an object thereof is lower than, or equal to 30 degrees/second.

6. A picture processing apparatus for producing an interpolation frame of a picture signal, comprising:
a motion vector detecting unit for detecting a motion vector of a picture;
a character detecting unit for detecting a character contained in the picture and for calculating a frame rate based upon said detected character; and
an interpolation frame producing unit for producing an interpolation frame based upon the motion vector of the picture detected by said motion vector detecting unit and the character detected by said character detecting unit;
wherein said character detecting unit calculates a movement feature amount of said detected character from the motion vector of the picture detected by said motion vector detecting unit, and calculates the frame rate in such a manner that a frame rate of a picture, in which the movement feature amount of said character exceeds a predetermined threshold value, becomes lower than a frame rate of a picture in which the movement feature amount of the character is smaller than, or equal to said predetermined threshold value.

7. A picture processing apparatus as claimed in claim 6, further comprising:
a display unit for displaying thereon a picture;
wherein said display unit displays thereon the picture in the frame rate calculated by said frame rate calculating unit.

8. A picture processing apparatus as claimed in claim 6 wherein:
said motion vector detecting unit detects the motion vector histogram distribution value of the picture; and
said character detecting unit detects a character of a predetermined area of an inputted picture, calculates a movement feature amount of said character by employing a motion vector histogram distribution value of the character of said predetermined area detected by said motion vector detecting unit, and calculates a frame rate based upon said calculated movement feature amount of the character.

9. A picture processing apparatus as claimed in claim 8 wherein:
said character detecting unit utilizes, as a typical value, any one of an averaged value, a center value, and a mode of the motion vector histogram distribution value detected by said motion vector detecting unit.

10. A picture processing apparatus as claimed in claim 8 wherein:
said predetermined area is an area of a lower portion of said inputted picture along a vertical direction.

11. A picture processing apparatus as claimed in claim 6, wherein
the picture, the movement feature amount of which exceeds said predetermined threshold value, corresponds to a picture in which an angular velocity of said detected character is higher than 30 degrees/second; and the picture, the movement feature amount of which is smaller than, or equal to said predetermined threshold value, corresponds to a picture in which an angular velocity of said detected character is lower than, or equal to 30 degrees/second.

12. A picture processing apparatus as claimed in claim 2, further comprising:
a backlight unit for emitting light on a rear side of said display unit; and
a backlight control unit for controlling the light emission of said backlight unit;
wherein said backlight control unit controls said backlight unit based upon the frame rate calculated by said frame rate calculating unit.

13. A picture processing method for producing an interpolation frame of a picture signal, comprising:
a motion vector detecting step for detecting a motion vector of a picture;
a frame rate calculating step for calculating a frame rate based upon said detected motion vector; and
an interpolation frame producing step for producing an interpolation frame based upon said calculated frame rate;
wherein in said frame rate calculating step, a movement feature amount of a picture is calculated from the motion vector detected in said motion vector detecting step; and the frame rate is calculated in such a manner that a frame rate of a picture, the movement feature amount of which exceeds a predetermined threshold value, becomes lower than a frame rate of a picture, the movement feature amount of which is smaller than, or equal to said predetermined threshold value.
